(19) United States
(12) Patent Application Publication
(10) Pub. No.: US 2002/0085619 A1
(43) Pub. Date: Jul. 4, 2002

(54) Apparatus and method for transmitting a burst pilot channel in a mobile communication system

(75) Inventors: Young-Kwon Cho, Suwon-shi (KR); Ho-Kyu Choi, Sungnam-shi (KR); Sang-Min Bae, Suwon-shi (KR); Youn-Sun Kim, Seoul (KR); Jin-Woo Heo, Sungnam-shi (KR); Jong-Yoon Hwang, Songnam-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/037,755

(22) Filed: Oct. 22, 2001

(30) Foreign Application Priority Data
Oct. 20, 2000 (KR) 2000-61835

(51) Int. Cl. H04K 1/00

(52) U.S. Cl. 375/130

(57) ABSTRACT

Disclosed are a method and apparatus for transmitting a time-discontinuous burst pilot channel being dependent on transmission data in a mobile communication system. In the apparatus, a modulator generates a modulated pilot symbol by outputting an input pilot symbol at a designated at least one of phase and on a designated complex channel according to an information bit for determining at least one of the phase and/or the complex channel, and a spreader spreads the modulated pilot symbol from the modulator with an orthogonal code selected among a plurality of orthogonal codes. The burst pilot channel transmits side information being dependent on the transmission data according to the phase, and/or the complex channel and the orthogonal code.

### PRIORITY

This application claims priority to an application entitled “Apparatus and Method for Transmitting Burst Pilot Channel in a Mobile Communication System” filed in the Korean Industrial Property Office on Oct. 20, 2000 and assigned Serial No. 2000-61835, the contents of which are hereby incorporated by reference.

### BACKGROUND OF THE INVENTION

1. Field of the Invention

The present invention relates generally to a mobile communication system, and in particular, to an apparatus and method for transmitting information over a pilot channel.

2. Description of the Related Art

Recently, a mobile communication system supporting not only a voice service but also a high-speed packet data service has been proposed to meet the growing requirement for high-speed data transmission. In the mobile communication system supporting the high-speed packet data transmission, a transmitter performs QAM (Quadrature Amplitude Modulation) on transmission packet data. Further, the transmitter transmits a time-continuous common pilot channel and a time-discontinuous burst pilot channel.

Generally, a phase modulation scheme such as QPSK (Quadrature Phase Shift Keying) includes information in a phase component of a modulated symbol. Therefore, a receiver demodulates the modulated symbol by utilizing the common pilot channel as a phase reference signal. However, a QAM scheme includes information in amplitude and phase components of the modulated symbol. For example, when the system supporting the high-speed data transmission employs 16-QAM (16-ary QAM) or 64-QAM for packet data transmission, the receiver requires an amplitude reference of a demodulated symbol in order to correctly demodulate the information included in the modulated symbol. Therefore, the transmitter must transmit both a phase reference signal and an amplitude reference signal of the modulated symbol. That is, when the transmitter employing the QAM modulation transmits data at constant transmission power, the common pilot channel can be used as both the phase reference and the amplitude reference. However, when the transmission power varies at stated periods, a reference signal providing an amplitude reference of the QAM-modulated symbol is required. To provide the amplitude reference of the QAM-modulated symbol, the burst pilot channel is typically used. The burst pilot channel is used to provide only the amplitude reference of the QAM-modulated symbol. Generally, it is most important for the mobile communication system to efficiently utilize the limited radio resources. To this end, many multi-function channels have been proposed. Although the burst pilot channel is used to provide the amplitude reference of the modulated symbol, it can also provide other side information (or additional information), thus contributing to its efficient utilization.

### SUMMARY OF THE INVENTION

It is, therefore, an object of the present invention to provide an apparatus and method for transmitting side information using a burst pilot channel providing an amplitude reference of a modulated symbol.

It is another object of the present invention to provide an apparatus and method for transmitting side information using a phase component of a modulated burst pilot symbol providing an amplitude reference of a modulated symbol.

It is further another object of the present invention to provide an apparatus and method for transmitting side information using a complex output channel for a modulated burst pilot symbol providing an amplitude reference of a modulated symbol.

It is yet another object of the present invention to provide an apparatus and method for transmitting side information using a spreading code for a modulated burst pilot symbol providing an amplitude reference of a modulated symbol.

To achieve the above and other objects, there is provided an apparatus for transmitting a time-discontinuous burst pilot channel being dependent on transmission data in a mobile communication system. In the apparatus, a modulator generates a modulated pilot symbol by generating an input pilot symbol at a designated phase and/or on a designated complex channel in response to an information bit input signal for designating the phase and/or the complex channel, and a spreader spreads the modulated pilot symbol from the modulator with an orthogonal code selected among a plurality of orthogonal codes. The burst pilot channel transmits side information being dependent on the transmission data according to the phase, and/or the channel and the orthogonal code.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a structure of a forward link transmitter for a packet data service according to an embodiment of the present invention;

FIG. 2 illustrates a structure of a 1.25 msec slot comprised of packet data symbols and burst pilot symbols;

FIGS. 3A, 3B, and 3C illustrate various methods of transmitting side information using one modulated pilot symbol transmitted over a burst pilot channel according to an embodiment of the present invention;

FIG. 4 illustrates another structure of a 1.25 msec slot comprised of packet data symbols and burst pilot symbols;

FIGS. 5A, 5B, and 5C illustrate various methods of transmitting side information using two modulated pilot symbols transmitted over a burst pilot channel according to an embodiment of the present invention; and

FIGS. 6A and 6B illustrate various methods of transmitting side information using a spreading code for a modulated burst pilot symbol according to an embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

The present invention transmits side information over a burst pilot channel providing an amplitude reference of a modulated symbol, required for demodulating the QAM-modulated symbol received from a transmitter. The side information is required for packet data transmission, as follows:

(1) When a plurality of different packet data are transmitted to a packet data user over consecutive slots, the packet data user requires information to indicate the different packet data. The side information can be used to provide this information.

(2) Upon failure to correctly decode received packet data, the packet data user sends a retransmission request to a base station, and the base station then retransmits the same packet data in response to the retransmission request. The retransmitted data, though identical to the previously transmitted data, may be transmitted at a different code rate in a different modulation mode. The side information can be used to indicate whether to be first transmission data and to be retransmission data.

(3) The base station must inform the packet data user of a data rate of the packets being transmitted., the side information can be used to provide the data rate.

(4) The side information can be used as common control information for controlling a data rate of a reverse link used by a plurality of packet data users to transmit packet data to the base station. Further, the side information can also be used to control a data rate of a specific group or user. In addition, the side information bit can be used to transmit specific information even in a case other than the above-stated cases.

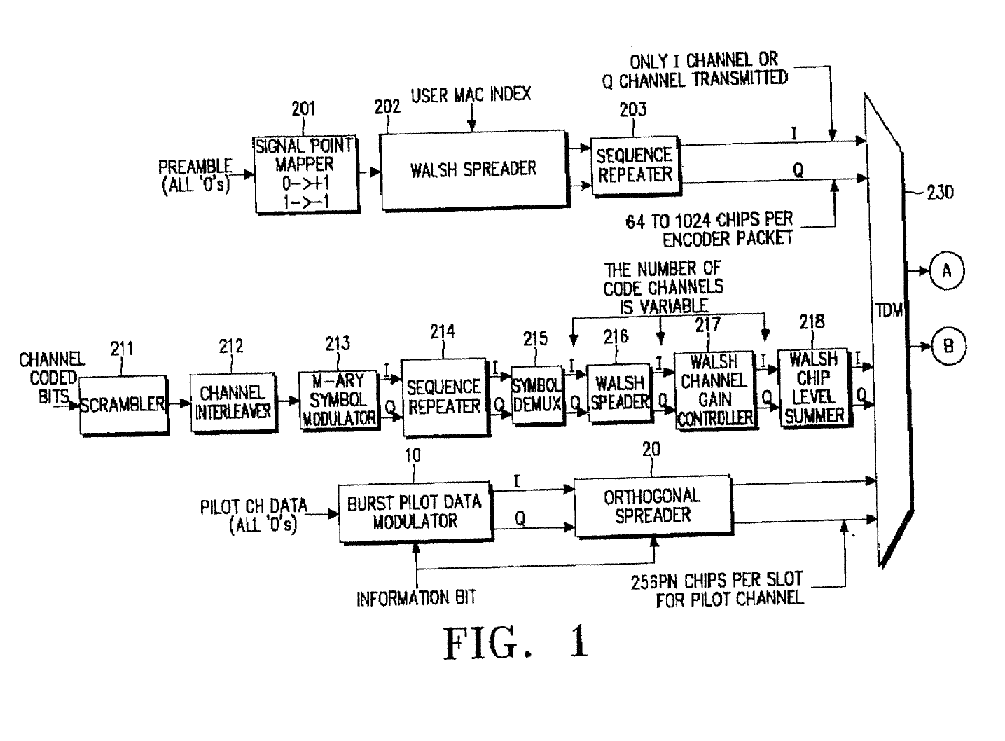

FIG. 1 illustrates a structure of a forward link transmitter for a packet data service according to an embodiment of the present invention. Particularly, the transmitter shown in FIG. 1 includes a burst pilot data modulator 10 and an orthogonal spreader (or Walsh cover generator) 20 according to the present invention. Upon receiving a symbol of ‘0’, the burst pilot data modulator 10 positions the received symbol in an I channel or a Q channel according to an information bit to be transmitted, or converts the received symbol to a symbol of ‘0’ or ‘1’. The converted symbol is spread with a predefined orthogonal code (e.g., Walsh code) for the burst pilot channel by the orthogonal spreader 20, and then, output in a chip unit. When transmitting side information using the orthogonal spreader 20 rather than the burst pilot data modulator 10, the orthogonal spreader 20 can multiply the side information by an orthogonal code, which is previously determined according to the information bit to be transmitted.

Referring to FIG. 1, input preamble symbols of all ‘0’s are mapped to ‘+1’ by a signal point mapper 201. The output symbols of the signal point mapper 201 are spread by a Walsh spreader 202 with a specific 64-ary biorthogonal Walsh code (or sequence) associated with a user's unique MAC ID (identification; or index). The Walsh spreader 202 outputs an I-channel sequence and a Q-channel sequence. The output sequences of the Walsh spreader 202 are provided to a sequence repeater 203 where they are subject to sequence repetition according to a transmission rate (or data rate). The output sequences of the Walsh spreader 202 can be repeated by the sequence repeater 203 as many as a maximum of 16 times according to the transmission rates. Therefore, the burst pilot channel included in one slot of a data traffic channel (DTCH) can continue for 64 chips to 1,024 chips according to the transmission rates. The I and Q-channel sequences output from the sequence repeater 203 are provided to a time division multiplexer (TDM) 230 where they are multiplexed with the data traffic channel and the burst pilot channel.

An input channel-coded bit sequence is scrambled by a scrambler 211, and then, interleaved by a channel interleaver 212. The size of the channel interleaver 212 depends on the size of a physical layer packet. The output sequence of the channel interleaver 212 is mapped to M-ary symbols by an M-ary symbol modulator 213. The M-ary symbol modulator 213 serves as the QPSK(Quadrature Phase Shift Keying), 8-PSK (8-ary Phase Shift Keying) or 16-QAM(Quadrature Amplitude Modulation) modulator according to the transmission rates, and it is also possible to change the modulation mode in a unit of the physical layer packet having a variable transmission rate. The I and Q sequences of the M-ary symbols output from the M-ary symbol modulator 213 are subjected to sequence repetition/symbol puncturing according to the transmission rate in a sequence repeater/symbol puncturer 214. The I and Q sequences of the M-ary symbols output from the sequence repeater/symbol puncturer 214 are provided to a symbol demultiplexer (DEMUX) 215 where they are demultiplexed into N Walsh code channels available for data traffic sub channels (DTSCHs). The number, N, of the Walsh codes used for the DTSCHs is variable: this information is broadcast over a Walsh space indication sub-channel (WSISCH), and a mobile station (MS) determines a transmission rate of a base station (BS), considering the received information, and then sends the determined transmission rate information to the base station. Therefore, the mobile station can determine which Walsh codes are assigned to the currently received DTSCH. The I and Q sequences, demultiplexed into N Walsh code channels, output from the symbol demultiplexer 215 are provided to a Walsh spreader (or a Walsh cover generator) 216 where they are spread with a specific Walsh code according to the respective channels. The I and Q sequences output from the Walsh spreader 216 are gain-controlled by a Walsh channel gain controller 217. The I and Q sequences output from the Walsh channel gain controller 217 are summed up in a chip unit by a Walsh chip level summer 218. The I and Q chip sequences output from the Walsh chip level summer 218 are provided to the time division multiplexer 230 where they are multiplexed with the burst pilot channel(PICH) and a preamble sub-channel (PSCH).

The burst pilot data modulator 10 (hereinafter, referred to as “modulator” for simplicity) performs signal mapping (0→+1, 1→−1) on the input pilot channel data of all ‘0’s, and outputs modulated pilot symbols. The orthogonal spreader 20 orthogonally spreads the signals output from the modulator 10 by multiplying the modulated pilot symbols by a predefined orthogonal code. In this process, the modulator 10 defines a sign (or phase) of the modulated pilot symbols according to the input information bit. For example, the modulator 10 outputs a modulated pilot symbol having a positive sign (+) for the input information bit of ‘0’, and a modulated pilot symbol having a negative sign (−) for the input information bit of ‘1’.

As another example, the modulator 10 performs signal mapping on the input pilot channel data, and outputs the mapped signal through a channel selected according to the input transmission information bit, among a plurality of channels (I channel and Q channel) constituting complex channels. For example, the modulator 10 outputs its output signal through the I channel for the input information bit of ‘0’, and through the Q channel for the input information bit of ‘1’.

In an alternative embodiment, the orthogonal spreader 20 can transmit the side information by spreading the modulated pilot symbol output from the modulator 10 with a specific orthogonal code selected according to the input information bit, among a plurality of orthogonal codes previously assigned for the burst pilot.

When the side information is transmitted over the burst pilot channel as stated above, a method for expressing the side information transmitted over the burst pilot channel by the burst pilot data modulator 10 and the orthogonal spreader 20 should be previously agreed between the transmitter and the receiver. Table 1 shows a method for expressing symbols selected according to the transmission information bit (0 or 1) and a method for assigning the information bit by the burst pilot data modulator 10. In Table 1, ‘X’ indicates that the position and the sign of the symbol are fixed according to the agreement between the transmitter and the receiver.

TABLE 1

| | Method of Expressing Symbols and | | | |
|---|---|---|---|---|
| | Assigning Info Bits Per Symbol | | | |
| | by Burst Pilot Data Modulator | | | |
| Tx Info | | Symbol | Symbol | Related |
| Bit(s) | Symbol Num. | output Pos. | output Sign. | Drawing |
| 1 | 1 symbol | X | Positive/Negative | |
| | (128-chip | (0 bit/symbol) | (1 bit/symbol) | |
| | length) | | | |
| 1 | 1 symbol | I channel/ | X | |
| | (128-chip | Q channel | (0 bit) | |
| | length) | (1 bit/symbol) | | |
| 2 | 1 symbol | I channel/ | Positive/Negative | |
| | (128-chip | Q channel | (1 bit/symbol) | |
| | length) | (1 bit/symbol) | | |
| 2 | 2 symbols | X | Positive/Negative | |
| | (64-chip | (0 bit/symbol) | (1 bit/symbol) | |
| | length) | | | |
| 2 | 2 symbols | I channel/ | X | |
| | (64-chip | Q channel | (0 bit) | |
| | length) | (1 bit/symbol) | | |
| 4 | 2 symbols | I channel/ | Positive/Negative | |
| | (64-chip | Q channel | (1 bit/symbol) | |
| | length) | (1 bit/symbol) | | |

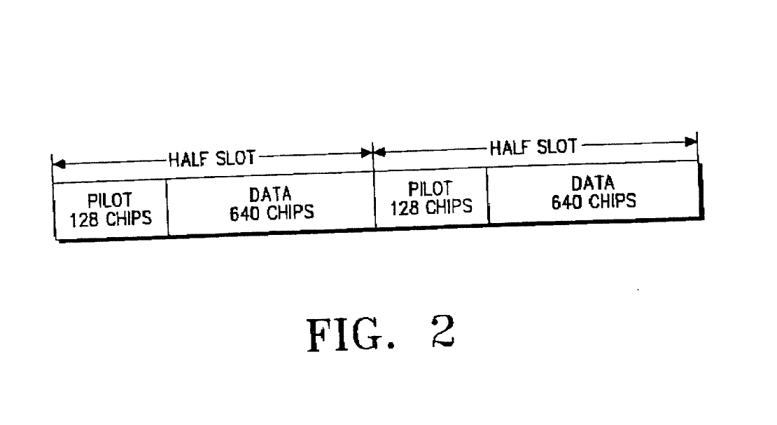

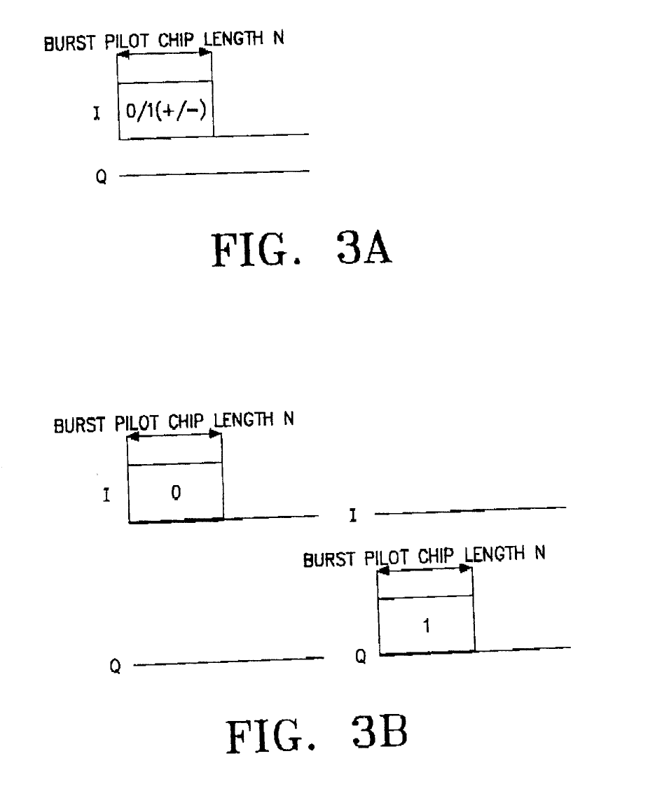

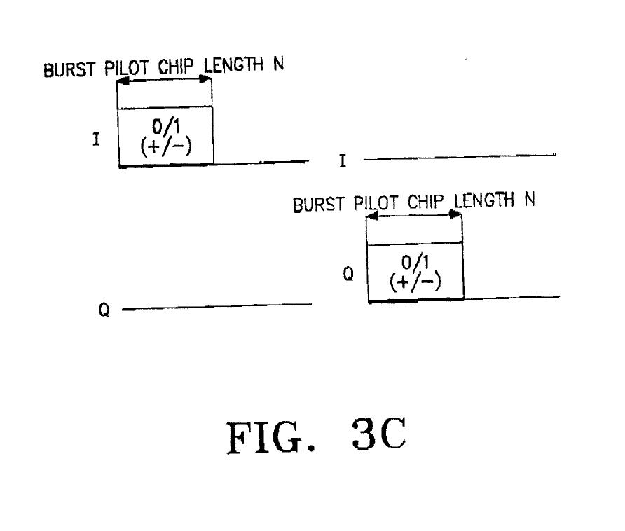

FIG. 2 illustrates a structure of a 1.25 msec slot comprised of packet data symbols and burst pilot symbols. As illustrated, one slot is comprised of two half slots and the burst pilot symbol is positioned in a leading 128-chip part of each half slot. When one 128-chip burst pilot symbol is constructed as shown in FIG. 2, it is possible to transmit a maximum of 2 information bits according to a sign of the output burst pilot symbol and a position of the complex output channel. In order to transmit one information bit, it is possible to select one method out of a first method for loading the information on a phase (+/−) of the symbol and a second method for designating a position of the complex channel for outputting the modulated symbol. A description of FIGS. 3A to 3C will be given under the assumption that the slot has the structure shown in FIG. 2.

FIG. 3A illustrates a method for transmitting one information bit by designating a phase of one modulated pilot symbol transmitted over a burst pilot channel. The modulated pilot symbol has a length of 128 chips. As illustrated in FIG. 3A, information is loaded on a sign (or phase) of a modulated symbol transmitted over the I channel. For example, the modulated symbol is transmitted with a positive sign (or negative sign) for the information bit of ‘0’, while the modulated symbol is transmitted with a negative sign (or positive sign) for the information bit of ‘1’. In this manner, the one information bit is transmitted. Although the description has been made of the method for transmitting information using a phase of the modulated symbol transmitted over the I channel out of the complex channels, it is also possible to transmit the information using a phase of a modulated symbol transmitted over the Q channel rather than the I channel. The phase of the modulated symbol, associated with the information bit value, is previously fixed (or designated).

FIG. 3B illustrates a method for transmitting one information bit by designating one channel out of complex channels, for outputting one modulated pilot symbol transmitted over the burst pilot channel. As illustrated in FIG. 3B, information is transmitted through a selected channel (I channel or Q channel) out of the complex channels according to the information bit. An output sign of the symbol is preset to a positive value (+), and then, the pilot symbol is generated on the selected channel. For example, the pilot symbol is transmitted through the I channel (or Q channel) out of the complex channels for the information bit of ‘0’, while the pilot symbol is transmitted through the Q channel (or I channel) for the information bit of ‘1’. In this manner, it is possible to transmit the one information bit. The complex output channel for the information bit is previously fixed (designated). It is also possible to previously set the sign of the modulated symbol to a negative value (−) rather than a positive value (+).

FIG. 3C illustrates a method for transmitting two information bits by designating a phase of one modulated pilot symbol transmitted over a burst pilot channel and also designating a complex output channel for the modulated pilot symbol. This method is a combination of the methods of FIGS. 3A and 3B. As illustrated, a sign (or complex output channel) of a modulated symbol is designated in association with a first information bit, and a complex output channel (or phase) of the modulated symbol is designated in association with a second information bit. For example, if a first information bit out of the two information bits to be transmitted is ‘0’, the modulated symbol is transmitted with a positive sign (or negative sign). Otherwise, if the first information bit is ‘1’, the modulated symbol is transmitted with a negative sign (or positive sign). In addition, if a second information bit out of the two transmission information bits is ‘0’, the modulated pilot symbol is transmitted through the I channel (or Q channel) out of the complex channels. Otherwise, if the second information bit is ‘1’, the modulated pilot symbol is transmitted through the Q channel (or I channel) of the complex channels.

As another example, if the first information bit of the two transmission information bits is ‘0’, the modulated pilot symbol is transmitted through the I channel (or Q channel). If the first information bit is ‘1’, the modulated pilot symbol is transmitted through the Q channel (or I channel). If the second information bit is ‘0’, the modulated pilot symbol is transmitted with a positive sign (or negative sign). If the second information bit is ‘1’, the modulated pilot symbol is transmitted with a negative sign (or positive sign).

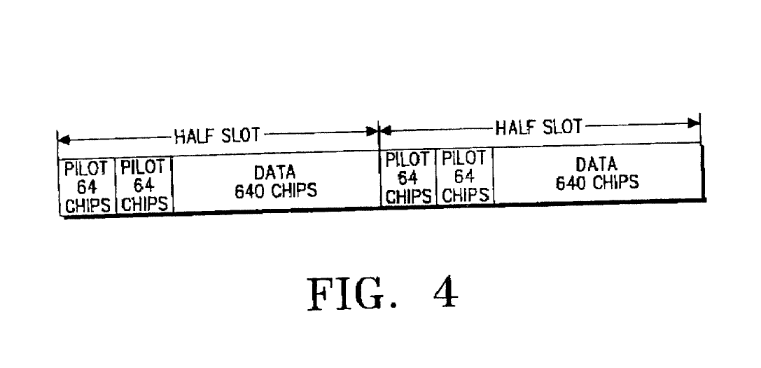

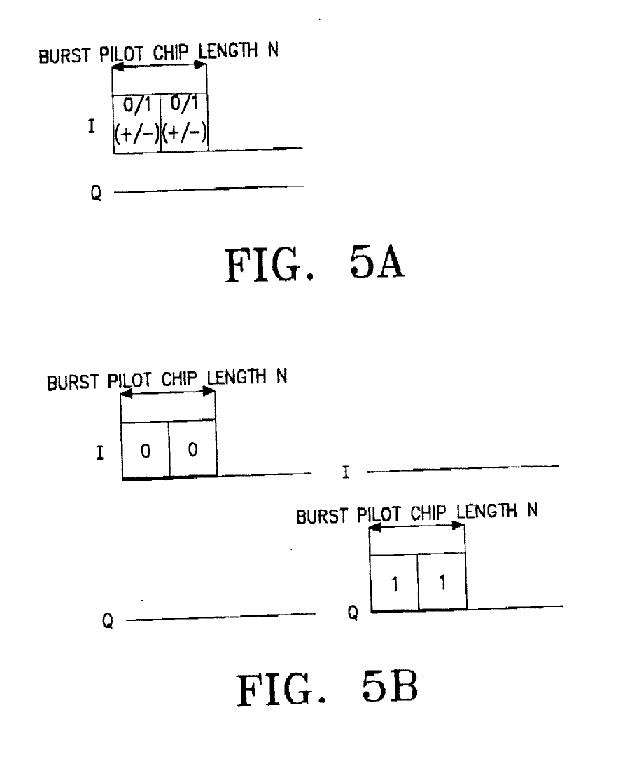

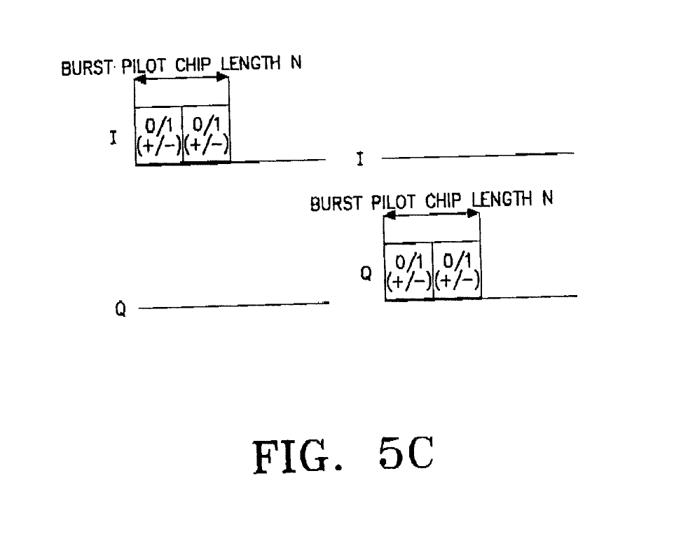

FIG. 4 illustrates another structure of a 1.25 msec slot comprised of packet data symbols and burst pilot symbols. As illustrated, one slot is comprised of two half slots, and each burst pilot channel is comprised of two consecutive 64-chip burst pilot symbols positioned in a leading part of each half slot. When two 64-chip burst pilot symbols are constructed as shown in FIG. 4, it is possible to transmit a maximum of 4 information bits by selecting a sign (or phase) of the modulated pilot symbols and selecting a complex channel for transmitting the modulated symbols. A description of FIGS. 5A to 5C will be given under the assumption that the slot has the structure illustrated in FIG. 4.

FIG. 5A illustrates a method for transmitting 2 information bits by separately designating a phase of two modulated pilot symbols transmitted over a burst pilot channel. The modulated pilot symbol has a length of 64 chips. As illustrated, the information bits are transmitted by separately designating a sign (or phase) of the two 64-chip modulated pilot symbols positioned in the leading part of each half slot. Here, it is assumed that the modulated pilot symbols are transmitted through only the I channel out of the complex channels. For example, if the first information bit out of the two information bits is ‘0’, the first modulated pilot symbol is transmitted with a positive sign (or negative sign). If the first information bit is ‘1’, the first modulated pilot symbol is transmitted with a negative sign (or positive sign). In addition, if the second information bit of the two information bits is ‘0’, the second modulated pilot symbol is transmitted with a positive sign (or negative sign). If the second information bit is ‘1’, the second modulated pilot symbol is transmitted with a negative sign (or positive sign). That is, one information bit is transmitted per one modulated pilot symbol, so that it is possible to transmit two information bits for a 128-chip period of the two modulated pilot symbols. The phase of the modulated symbols, which is associated with the information bit values, are previously fixed to a positive value (+) or a negative value (−). For example, the phase can be fixed to a positive value (+) for the information bit of ‘0’, and a negative value (−) for the information bit of ‘1’.

FIG. 5B illustrates a method for transmitting two information bits by separately designating a complex output channel for two modulated pilot symbols transmitted over the burst pilot channel. As illustrated, the information bits are transmitted by separately designating a complex output channel for the two modulated pilot symbols. For example, if the first information bit of the two information bits is ‘0’, the first modulated pilot symbol is transmitted through the I channel (or Q channel). If the first information bit is ‘1’, the first modulated pilot symbol is transmitted through the Q channel (or I channel). In addition, if the second information bit of the two information bits is ‘0’, the second modulated pilot symbol is transmitted through the I channel (or Q channel). If the second information bit is ‘1’, the second modulated pilot symbol is transmitted through the Q channel (or I channel). That is, one information bit is transmitted per one modulated pilot symbol for a 64 chips period, so that it is possible to transmit two information bits for a 128-chip period of the two modulated pilot symbols.

FIG. 5C illustrates a method for transmitting four information bits by separately designating a phase of two modulated pilot symbols transmitted over a burst pilot channel and also separately designating a complex output channel for the modulated pilot symbols. The modulated pilot symbols has a length of 64 chips. This method is a combination of the methods of FIGS. 5A and 5B. As illustrated in FIG. 5C, Thus, four information bits are transmitted by designating a sign(or phase) of the modulated pilot symbol and also designating an complex output channel for the modulated pilot symbol. Here, the sign and the complex channel of the modulated symbols, which are associated with the information bit values, are previously designated. For example, to transmit 4 information bits, the first modulated pilot symbol is transmitted with a negative sign (−) or a positive sign (+) according to the first information bit of the four information bits, and the first modulated pilot symbol is transmitted through the I channel or the Q channel of the complex channels according to the second information bit. In addition, the second modulated pilot symbol is transmitted with a negative sign (−) or a positive sign (+) according to the third information bit, and the second modulated pilot symbol is transmitted through the I channel or the Q channel of the complex channels according to the fourth information bit.

In an alternative embodiment, it is also possible to transmit the side information using the orthogonal spreader 20, rather than the modulator 10. The modulated symbols output from the modulator 10 are provided to the orthogonal spreader 20. The orthogonal spreader 20 spreads the modulated symbols with a predefined orthogonal code (e.g., Walsh code) in order to distinguish the modulated burst pilot symbols from other code channels. If the number of the predetermined orthogonal codes for the burst pilot channel is one, it is not possible to transmit the side information. However, when two orthogonal codes are used, it is possible to transmit one information bit. If the modulated burst pilot symbols output from the modulator 10 are spread with a selected one of 2ⁿ orthogonal codes, it is possible to transmit n information bits. In this case, it should be previously agreed between the mobile station and the base station that there are 2ⁿ available orthogonal codes.

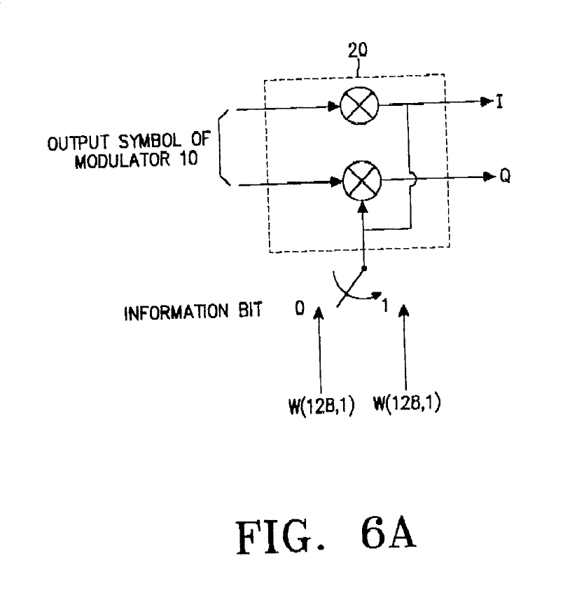

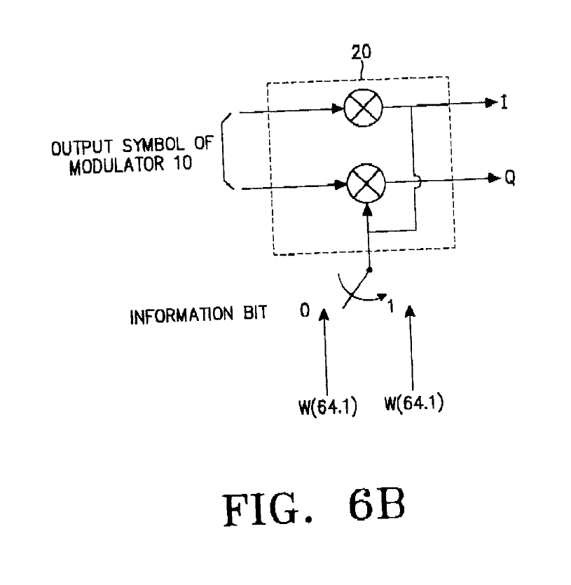

FIGS. 6A and 6B illustrate a method for transmitting side information using spreading codes for a burst pilot channel according to different embodiments of the present invention. Specifically, FIG. 6A illustrates a method for transmitting one modulated pilot symbol over the burst pilot channel, wherein the modulated pilot symbols output from the burst pilot data modulator 10 are spread with an orthogonal code selected according to the transmission information bit, out of two orthogonal codes. Which orthogonal code is to be selected out of the two orthogonal codes is determined according to the transmission information bit. When orthogonal codes having i^{th} and j^{th} indexes for spreading one modulated symbol into 128 chips are defined as W(128,i) and W(128,j), respectively, the orthogonal spreader 20 spreads the modulated symbol output from the modulator 10 with W(128,i) (or W(128,j)) for the transmission information bit of ‘0’, and spreads the modulated symbol with W(128,j) (or W(128,i)) for the transmission information bit of ‘1’, thereby transmitting one information bit.

In this manner, it is possible to transmit n information bits by alternately selecting one of the 2ⁿ orthogonal codes for spreading. When used along with the methods of FIG. 3A and FIG. 3B, this scheme can transmit (n+1) information bits. Further, when used along with the method of FIG. 3C, this scheme can transmit (n+2) information bits, because the modulator 10 can load two information bits on the modulated pilot symbol as shown in FIG. 3C and then n information bits can be further loaded by the above-stated spreading code selecting method.

FIG. 6B illustrates a method for transmitting two modulated pilot symbols over the burst pilot channel, wherein the two modulated pilot symbols output from the burst pilot data modulator 10 are spread with an orthogonal code selected according to the transmission information bit, out of two orthogonal codes. The modulated symbols output from the modulator 10 are spread with a 64-chip orthogonal code. When orthogonal codes having i^{th} and j^{th} indexes for spreading one modulated symbol into 64 chips are defined as W(64,i) and W(64,j), respectively, the orthogonal spreader 20, to transmit two information bits, spreads the first modulated symbol output from the modulator 10 with W(64,i) (or W(64,j)) for the first information bit of ‘0’, and spreads the first modulated symbol with W(64,j) (or W(64,i)) for the first information bit of ‘1’, thereby transmitting one information bit. In addition, the orthogonal spreader 20 spreads the second modulated symbol output from the modulator 10 with W(64,i) (or W(64,j)) for the second information bit of ‘0’, and spreads the second modulated symbol with W(64,j) (or W(64,i)) for the second information bit of ‘1’, thereby transmitting one information bit.

In this way, it is possible to transmit 2n information bits by alternately selecting one of the 2ⁿ orthogonal codes for spreading. When used along with the methods of FIG. 5A and FIG. 5B, this scheme can transmit (2n+2) information bits. Further, when used along with the method of FIG. 5C, this scheme can transmit (2n+4) information bits.

As described above, the apparatus and method according to the present invention can transmit side information as well as amplitude reference for demodulation over the burst pilot channel according to the number of modulated pilot symbols transmitted over the burst pilot channel, the complex channels for transmitting the modulated pilot symbols, the sign of the modulated pilot symbols, and the number of the orthogonal spreading codes used for the pilot channel.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for transmitting a time-discontinuous burst pilot channel dependent on transmission data in a mobile communication system, comprising:
a modulator for generating a modulated pilot symbol by outputting an input pilot channel data at at least one of a designated phase and on a designated complex channel according to an information bit for designating at least one of the phase and the complex channel; and
a spreader for spreading the modulated pilot symbol from the modulator with an orthogonal code selected among a plurality of orthogonal codes;
wherein the burst pilot channel transmits side information being dependent on the transmission data according to at least one of the phase, and the complex channel and the orthogonal code.

2. The apparatus as claimed in claim 1, wherein the modulated pilot symbol has a length of 128 chips.

3. The apparatus as claimed in claim 1, wherein the modulated pilot symbol has a length of 64 chips.

4. The apparatus as claimed in claim 1, wherein the complex channel includes an I channel and a Q channel.

5. An apparatus for transmitting side information over a burst pilot channel in a mobile communication system, comprising:
a modulator for generating a modulated pilot symbol by outputting an input pilot channel data at a designated phase according to an information bit for determining the phase; and
a spreader for spreading a modulated pilot symbol output from the modulator with a predefined orthogonal code.

6. An apparatus for transmitting side information over a burst pilot channel in a mobile communication system, comprising:
a modulator for generating a modulated pilot symbol by outputting an input pilot channel data on a designated complex channel according to an information bit for determining the complex channel; and
a spreader for spreading a modulated pilot symbol output from the modulator with a predefined orthogonal code.

7. An apparatus for transmitting side information over a burst pilot channel in a mobile communication system, comprising:
a modulator for generating a burst pilot symbol; and
a spreader for spreading the burst pilot symbol with an orthogonal code selected according to an information bit, from a plurality of orthogonal codes.

8. An apparatus for transmitting side information over a burst pilot channel in a mobile communication system, comprising:
a modulator for generating a modulated pilot symbol by outputting an input pilot channel data at a designated phase according to an information bit for designating the phase; and
a spreader for spreading the modulated pilot symbol with an orthogonal code selected according to the information bit, from a plurality of orthogonal codes.

9. An apparatus for transmitting side information over a burst pilot channel in a mobile communication system, comprising:
a modulator for generating a modulated pilot symbol by outputting an input pilot channel data on a designated complex channel according to an information bit for determining the complex channel; and
a spreader for spreading the modulated pilot symbol with an orthogonal code selected according to the information bit, from a plurality of orthogonal codes.

10. A method for transmitting a time-discontinuous burst pilot channel dependent on transmission data in a mobile communication system, comprising the steps of:
generating a modulated pilot symbol by outputting an input pilot symbol at at least one of a designated phase and on a designated complex channel according to an information bit for determining at least one of the phase and the complex channel; and
spreading the modulated pilot symbol with an orthogonal code selected from a plurality of orthogonal codes;
wherein the burst pilot channel transmits side information being dependent on the transmission data according to the phase, and/or the complex channel and the orthogonal code.

11. The method as claimed in claim 10, wherein the modulated pilot symbol has a length of 128 chips.

12. The method as claimed in claim 10, wherein the modulated pilot symbol has a length of 64 chips.

13. The method as claimed in claim 10, wherein the complex channel includes an I channel and a Q channel.

14. A method for transmitting side information over a burst pilot channel in a mobile communication system, comprising the steps of:
generating a modulated pilot symbol by outputting an input pilot symbol at a designated phase according to an information bit for determining the phase; and
spreading the generated modulated pilot symbol with a predefined orthogonal code.

15. A method for transmitting side information over a burst pilot channel in a mobile communication system, comprising the steps of:
generating a modulated pilot symbol by outputting an input pilot symbol on a designated complex channel according to an information bit for determining the complex channel; and
spreading the generated modulated pilot symbol with a predefined orthogonal code.

16. A method for transmitting side information over a burst pilot channel in a mobile communication system, comprising the steps of:
generating a pilot symbol; and
spreading the generated pilot symbol with an orthogonal code selected according to an information bit, from a plurality of orthogonal codes.

17. A method for transmitting side information over a burst pilot channel in a mobile communication system, comprising the steps of:
generating a modulated pilot symbol by outputting an input pilot symbol at a designated phase according to an information bit for determining the phase; and
spreading the generated modulated pilot symbol with an orthogonal code selected according to the information bit input signal, from a plurality of orthogonal codes.

18. A method for transmitting side information over a burst pilot channel in a mobile communication system, comprising the steps of:
generating a modulated pilot symbol by outputting an input pilot symbol on a designated complex channel according to an information bit for determining the complex channel; and
spreading the generated modulated pilot symbol with an orthogonal code selected according to the information bit, from a plurality of orthogonal codes.
